(19) United States
(12) Patent Application Publication
(10) Pub. No.: US 2006/0001903 A1
(43) Pub. Date: Jan. 5, 2006

(54) Image processing apparatus and image processing method

(75) Inventor: Takao Ikuno, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/168,522

(22) Filed: Jun. 29, 2005

(30) Foreign Application Priority Data
Jul. 1, 2004 (JP) 2004-195432

(51) Int. Cl. G06F 15/00

(52) U.S. Cl. 358/1.15

(57) ABSTRACT

This invention provides an image processing apparatus which can enhance the communication reliability while the user can use the apparatus without any consciousness of whether the receiver complies with network data of a color image. In the image processing apparatus of this invention, when the scanning mode of an input image is the color mode, a communication mode representing a mode used to transmit the input image is further determined. When the communication mode determination result represents the monochrome communication mode, a file of the monochrome format is created on the basis of the input image, and transmitted. When the scanning mode is the color mode, the input image is scanned in the color mode to generate color scanned data. A file of the monochrome format may be created on the basis of the color scanned data.

### FIELD OF THE INVENTION

The present invention relates to a multi function peripheral (to be referred to as MFP hereinafter) apparatus capable of executing a plurality of jobs such as a scan job, print job, and facsimile job by one apparatus and, more particularly, to the software control configuration of the MFP apparatus.

### BACKGROUND OF THE INVENTION

An Internet Fax has been available as an image communication apparatus which exchanges data with a network and transmits/receives an image and text data. The Internet FAX packages image data accumulated in a memory into a TIFF image format and sends the package to a network.

As the TIFF image format used in the Internet FAX, TIFF-S TIFF-F, and TIFF-C packages are proposed by RFC 2301.

Of these packages, TIFF-C is compliant with a color image, but the remaining TIFF-S and TIFF-F do not permit transmission/reception of a color image.

If a color image is transmitted to an Internet FAX compliant with only TIFF-S and TIFF-F, the Internet FAX cannot receive the color image, and the receiver ends with an error upon reception of the color image.

To prevent this, when a transmission destination is registered in abbreviated dialing or the like, a communication method such as “transmit by TIFF-S” or “transmit by TIFF-F” can be set for the abbreviated dialing. When transmission to a network is designated by the abbreviated dialing, a transmission request which does not comply with the communication method is not accepted. For example, when transmission by color scanning is designated for abbreviated dialing whose communication setting is “transmit by TIFF-F (monochrome)”, no data is transmitted, and transmission operation is inhibited unless the user performs scanning in the monochrome mode.

FIG. 1 shows a conventional example of creating image data to be transmitted to a network.

Transmission by abbreviated dialing at which the E-Mail address of a transmission destination is registered is designated (S101). Transmission operation of an image starts with a start key (S102). If a request to a scanner with the start key represents the color mode, the scanner prepares for color scanning; if the request to the scanner represents the monochrome mode, the scanner prepares for monochrome scanning (S103). In the monochrome mode, monochrome image files of TIFF-F and TIFF-S are created and transmitted to a network (S104).

In the color mode, it is determined whether the communication mode of abbreviated dialing is color or monochrome (S105). If the communication setting of the abbreviated dialing is “color IFAX mode”, a color image is scanned, and a color TIFF-C file is created and transmitted to the network (S106). If the setting of the abbreviated dialing is a monochrome communication mode such as “TIFF-F mode”, no image is scanned, and the process ends with an error before transmission (S107).

When a machine capable of transmitting color and monochrome Internet FAX image data adopts the conventional color image data transmission inhibiting method, the user must grasp the communication mode of the Internet FAX that is registered in each abbreviated dialing.

The user is likely to be confused because some abbreviated dialing numbers permit color transmission and some abbreviated dialing numbers inhibit it.

When a so-called transfer function is used to transmit an image received from another machine, it is difficult for the transfer source to know an image receivable by the transfer destination. Since the transfer destination cannot ask the transfer source to transmit an image again, transfer fails.

The present invention has been made to overcome the conventional drawbacks, and provides an image processing apparatus and image processing method which can create data reliably receivable by a receiver and enhance the communication reliability while the user can use the apparatus without any consciousness of whether the receiver complies with network data of a color image.

### SUMMARY OF THE INVENTION

According to the present invention, an image processing apparatus which generates image data to be transmitted to a predetermined network, comprises:
scanning mode determination means for determining whether a scanning mode of an input image is a monochrome mode or a color mode;
communication mode determination means for, when the scanning mode is the color mode, determining a communication mode representing a mode used to transmit the input image;
file creation means for, when a determination result by the communication mode determination means represents a monochrome communication mode, creating a file of a monochrome format on the basis of the input image; and
transmission means for transmitting the file of the monochrome format.

According to the present invention, an image processing method of generating image data to be transmitted to a predetermined network, comprises:
a scanning mode determination step of determining whether a scanning mode of an input image is a monochrome mode or a color mode;
a communication mode determination step of, when the scanning mode is the color mode, determining a communication mode representing a mode used to transmit the input image;
a file creation step of, when a determination result in the communication mode determination step represents a monochrome communication mode, creating a file of a monochrome format on the basis of the input image; and
a transmission step of transmitting the file of the monochrome format.

Other features and advantages of the present invention will be apparent from the following description taken in conjunction with the accompanying drawings, in which like reference characters designate the same name or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a flowchart showing transmission operation of color/monochrome data by a conventional MFP apparatus;

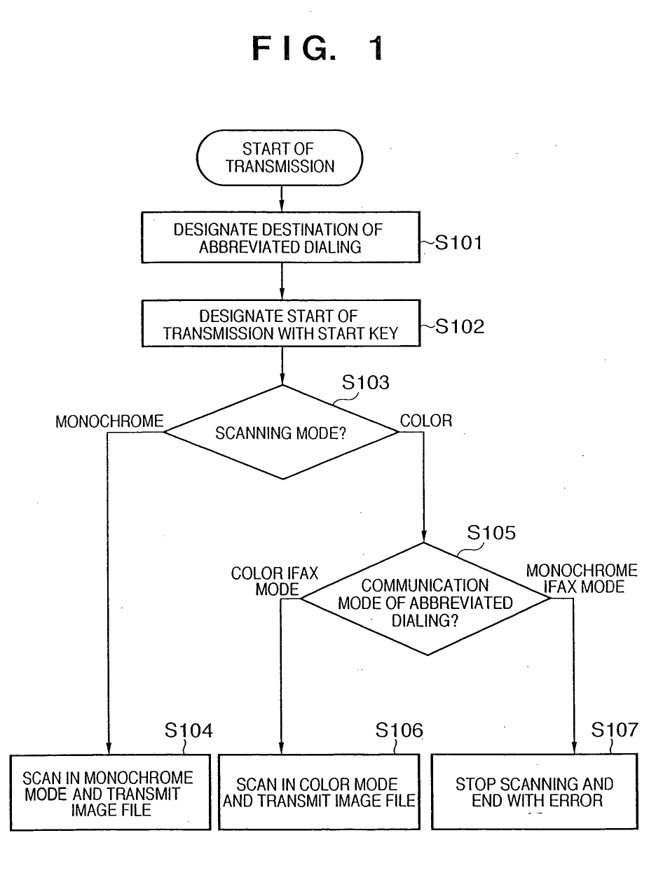

FIG. 2 is a block diagram showing the configuration of an image processing apparatus 200 according to the present invention;

FIG. 3 is a view schematically showing a case in which the operation panel of an MFP apparatus according to the present invention is in a normal state;

FIG. 4 is a view schematically showing a case in which the operation panel of the MFP apparatus according to the present invention is in a transmission state;

FIG. 5 is a flowchart showing transmission operation of color/monochrome data according to the first embodiment of the present invention; and

FIG. 6 is a flowchart showing transmission operation of color/monochrome data according to the second embodiment of the present invention.

### DETAILED DESCRIPTION OF THE PREFERRED EMBODIMENTS

Preferred embodiments of the present invention will now be described in detail in accordance with the accompanying drawings.

A data processing apparatus according to the present invention will be described by exemplifying an MFP (Multi Function Peripheral) apparatus.

<Hardware Configuration>

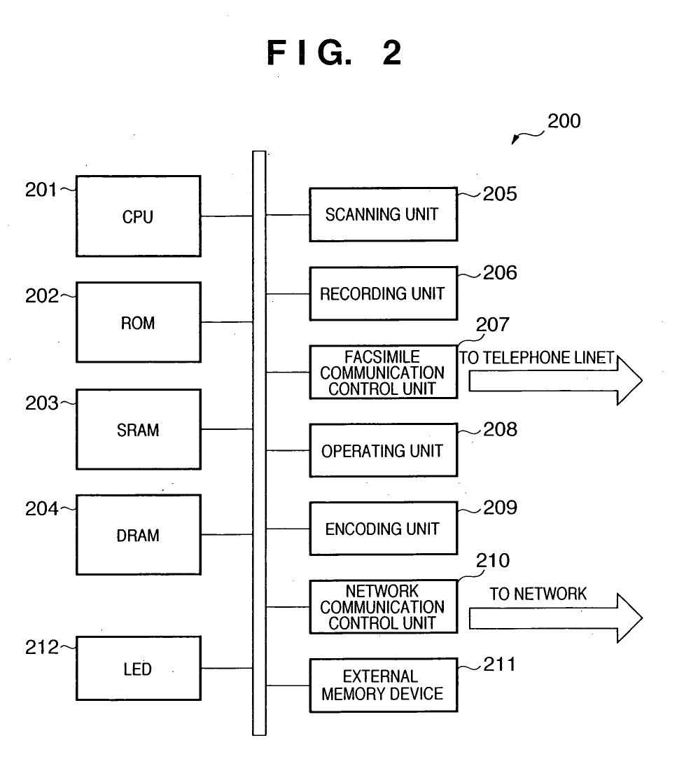

FIG. 2 is a block diagram showing the configuration of an image processing apparatus according to an embodiment of the present invention.

Reference numeral 201 denotes a CPU (Central Processing Unit) which functions as a system control unit to control the entire apparatus. Reference numeral 202 denotes a ROM (Read Only Memory) which stores control programs of the CPU 201, and more specifically, stores a program associated with a software encoding process (to be described later). The method of the encoding process includes JBIG, JPEG, binarization, MMR (Modified Modified Read), MR (Modified Read), MH (Modified Huffman), and the like, but is not limited to them.

Reference numeral 203 denotes an SRAM which is used to store setting values registered by the operator, management data of the apparatus and the like, and various work buffers and the like. Reference numeral 204 denotes a DRAM which is used to store program control variables and the like and accumulate image data and text data.

Reference numeral 205 denotes a scanning unit, more specifically, scanner unit which is a device having a function of scanning image data and converting it into binary data. Reference numeral 206 denotes a recording unit which has a printer function of outputting image data onto recording paper.

Reference numeral 207 denotes a facsimile communication control unit which is an interface for facsimile communication with a facsimile apparatus installed at a remote place via an external line such as a telephone line. Reference numeral 208 denotes an operating unit which is used for registration by the operator. More specifically, the operating unit 208 includes operating buttons such as a ten-key pad, a touch panel, and the like.

Reference numeral 209 denotes an encoding unit (CODEC) which is formed from a hardware chip, unlike the above-mentioned software encoding process. The embodiment adopts the hardware encoding unit in addition to the software encoding process because the process speed of the hardware encoding process is much higher than that of the software encoding process. However, arranging many hardware encoding chips increases the cost and size of the whole apparatus, and the number of chips is limited. The encoding unit 209 executes an encoding/decoding process for image data processed by a communication control apparatus, and a scaling process for an image.

Reference numeral 210 denotes a network communication control unit which has the function of an interface with a network line and is used to execute reception of a print job and Internet FAX transmission/reception. Reference numeral 211 denotes an external memory device which includes a removable memory (e.g., an SD memory card, smart medium, memory stick, or compact flash memory).

Reference numeral 212 denotes an LED which has a function of turning on or flickering during facsimile transmission/reception or network communication and externally presenting that the apparatus is in communication.

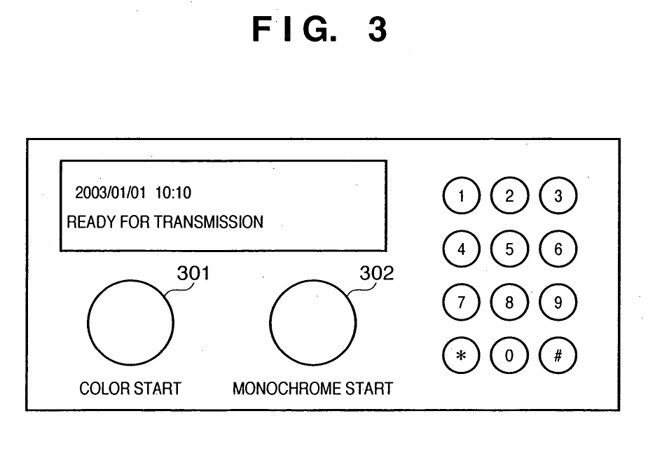

FIG. 3 is a view showing a case in which the operation panel of an MFP apparatus 200 is in a normal state (standby state without any operation). In the normal state, a message “ready for transmission” is displayed on the panel.

The MFP apparatus 200 according to the embodiment starts monochrome facsimile transmission by pressing a monochrome start button, and color facsimile transmission by pressing a color start button. That is, which of monochrome scanning and color scanning starts is determined by pressing either button.

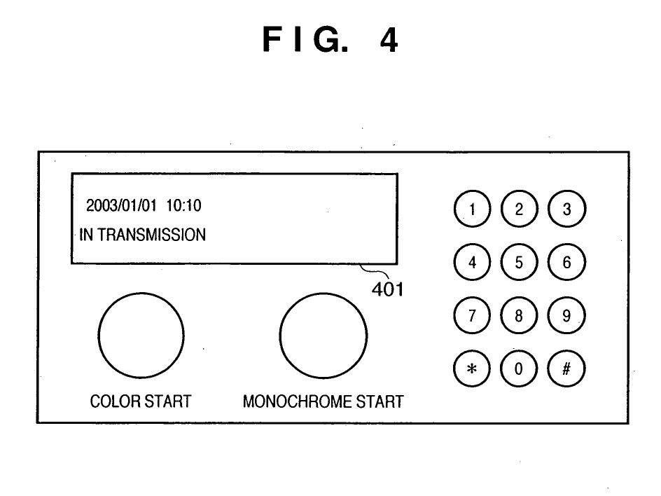

FIG. 4 is a view showing a case in which the operation panel of the MFP apparatus 200 is in a communication state. When the MFP apparatus is in FAX communication, a message “in transmission” or “in reception” is displayed on the panel.

<Process of Creating Color Internet FAX Data According to First Embodiment>

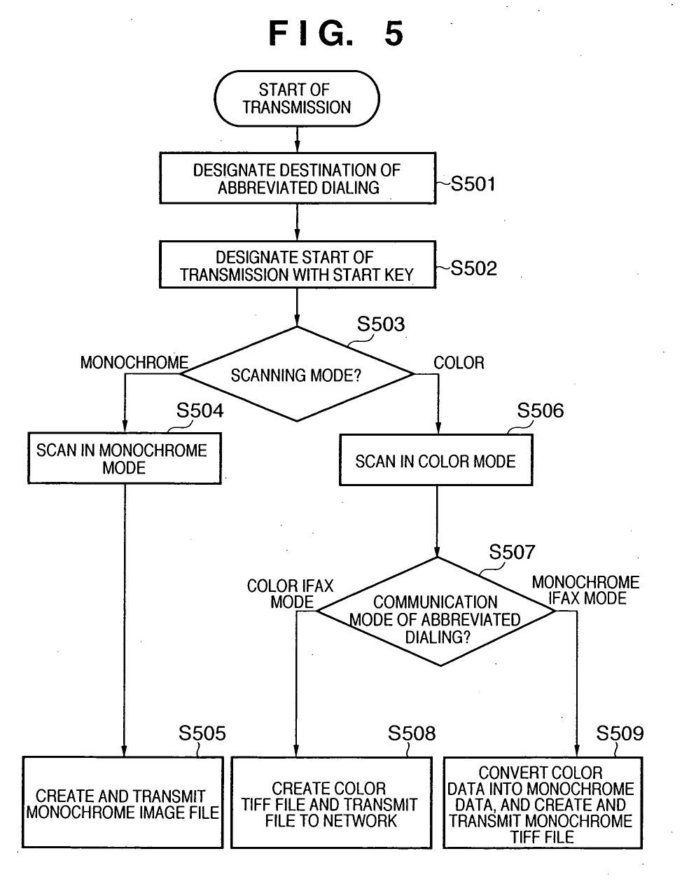

FIG. 5 is a flowchart showing a process of creating color Internet FAX data according to the first embodiment.

In step S501, transmission by abbreviated dialing at which the E-Mail address of a transmission destination is registered is designated. In step S502, transmission operation of an image starts with a start key. In step S503, it is determined whether the scanning mode based on the transmission start instruction in step S502 is monochrome or color. In the first embodiment, this determination is based on which of a color start button 301 and monochrome start button 302 has been pressed. In general, the user presses the color start button when a document to be scanned is a color image. The first embodiment can cope with even a case in which the monochrome start button is pressed for a document of a color image.

If the scanning mode designated by the start key is the monochrome mode, the process shifts to step S504 to execute monochrome scanning of an image. In step S505, monochrome image files of TIFF-F and TIFF-S are created from the scanned image, and transmitted to a network.

If the scanning mode is the color mode, the process shifts to step S506 to execute color scanning of a color image. In step S507, it is determined whether the communication setting of abbreviated dialing is the color IFAX mode or monochrome IFAX mode.

If the communication setting of abbreviated dialing is “color IFAX mode”, the process shifts to step S508 to create a color TIFF-C file and transmit it to the network.

If the setting of abbreviated dialing is a monochrome communication mode such as “TIFF-F mode”, the process shifts to step S509, and an encoding unit 209 converts the color of the scanned color image data by using MMR or the like, and creates monochrome binary image data. A monochrome TIFF image file is created and transmitted to the network.

By executing the above operation, the user can use the apparatus without any consciousness of whether the receiver complies with network data of a color image. Data reliably receivable by the receiver can be created, and the communication reliability can be enhanced, preventing a situation in which FAX data which has been transmitted by the user does not reach the destination.

<Process of Creating Color Internet FAX Data According to Second Embodiment>

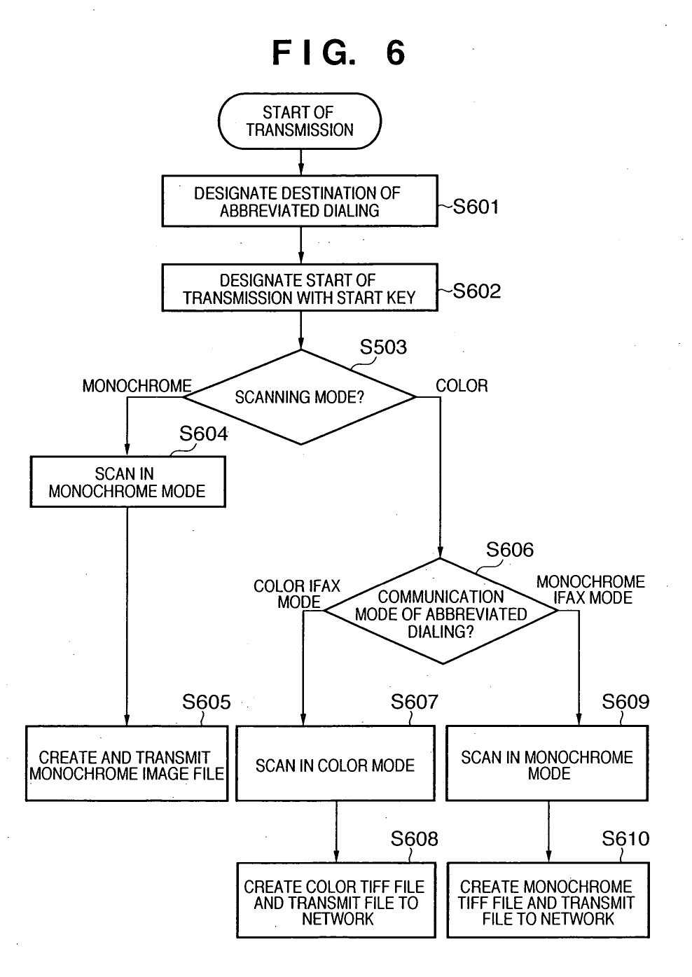

FIG. 6 is a flowchart showing a process of creating color Internet FAX data according to the second embodiment.

In step S601, transmission by abbreviated dialing at which the E-Mail address of a transmission destination is registered is designated. In step S602, transmission operation of an image starts with a start key. In step S603, it is determined whether the scanning mode based on the transmission start instruction in step S602 is monochrome or color. In the second embodiment, this determination is based on which of a color start button 301 and monochrome start button 302 has been pressed. In general, the user presses the color start button when a document to be scanned is a color image. The second embodiment can cope with even a case in which the monochrome start button is pressed for a document of a color image.

If the scanning mode designated by the start key is the monochrome mode, the process shifts to step S604 to execute monochrome scanning of an image. In step S605, monochrome image files of TIFF-F and TIFF-S are created from the scanned image, and transmitted to a network.

If the scanning mode is the color mode, the process shifts to step S606 to determine whether the communication setting of abbreviated dialing is the color IFAX mode or monochrome IFAX mode.

If the communication setting of abbreviated dialing is “color IFAX mode”, the process shifts to step S607 to execute color scanning of the color image. In step S608, a color TIFF-C file is created and transmitted to the network.

If the setting of abbreviated dialing is a monochrome communication mode such as “TIFF-F mode”, the process shifts to step S609 to scan the color image in the monochrome mode. In step S610, monochrome image files of TIFF-F and TIFF-S are created from the scanned image, and transmitted to the network.

By executing the above operation, the user can use the apparatus without any consciousness of whether the receiver complies with network data of a color image. Data reliably receivable by the receiver can be created, and the communication reliability can be enhanced, preventing a situation in which FAX data which has been transmitted by the user does not reach the destination.

### Other Embodiments

Note that the present invention can be applied to an apparatus comprising a single device or to system constituted by a plurality of devices.

Furthermore, the invention can be implemented by supplying a software program, which implements the functions of the foregoing embodiments, directly or indirectly to a system or apparatus, reading the supplied program code with a computer of the system or apparatus, and then executing the program code. In this case, so long as the system or apparatus has the functions of the program, the mode of implementation need not rely upon a program.

Accordingly, since the functions of the present invention are implemented by computer, the program code installed in the computer also implements the present invention. In other words, the claims of the present invention also cover a computer program for the purpose of implementing the functions of the present invention.

In this case, so long as the system or apparatus has the functions of the program, the program may be executed in any form, such as an object code, a program executed by an interpreter, or scrip data supplied to an operating system.

Example of storage media that can be used for supplying the program are a floppy disk, a hard disk, an optical disk, a magneto-optical disk, a CD-ROM, a CD-R, a CD-RW, a magnetic tape, a non-volatile type memory card, a ROM, and a DVD (DVD-ROM and a DVD-R).

As for the method of supplying the program, a client computer can be connected to a website on the Internet using a browser of the client computer, and the computer program of the present invention or an automatically-installable compressed file of the program can be downloaded to a recording medium such as a hard disk. Further, the program of the present invention can be supplied by dividing the program code constituting the program into a plurality of files and downloading the files from different websites. In other words, a WWW (World Wide Web) server that downloads, to multiple users, the program files that implement the functions of the present invention by computer is also covered by the claims of the present invention.

It is also possible to encrypt and store the program of the present invention on a storage medium such as a CD-ROM, distribute the storage medium to users, allow users who meet certain requirements to download decryption key information from a website via the Internet, and allow these users to decrypt the encrypted program by using the key information, whereby the program is installed in the user computer.

Besides the cases where the aforementioned functions according to the embodiments are implemented by executing the read program by computer, an operating system or the like running on the computer may perform all or a part of the actual processing so that the functions of the foregoing embodiments can be implemented by this processing.

Furthermore, after the program read from the storage medium is written to a function expansion board inserted into the computer or to a memory provided in a function expansion unit connected to the computer, a CPU or the like mounted on the function expansion board or function expansion unit performs all or a part of the actual processing so that the functions of the foregoing embodiments can be implemented by this processing.

Note that the shapes and structures of the respective elements shown in the above-described embodiments are merely given as an example of implementation of the present invention, and the technical scope of the present invention is not limitedly interpreted with these shapes and structures. That is, the present invention can be implemented in various forms without departing from its sprit and its principal features.

As many apparently widely different embodiments of the present invention can be made without departing from the spirit and scope thereof, it is to be understood that the invention is not limited to the specific embodiments thereof except as defined in the appended claims.

### CLAIM OF PRIORITY

This application claims priority from Japanese Patent Application No. 2004-195432 filed Jul. 1, 2004, which is hereby incorporated by reference herein.

1. An image processing apparatus which generates image data to be transmitted to a predetermined network, comprising:
scanning mode determination means for determining whether a scanning mode of an input image is a monochrome mode or a color mode;
communication mode determination means for, when the scanning mode is the color mode, determining a communication mode representing a mode used to transmit the input image;
file creation means for, when a determination result by said communication mode determination means represents a monochrome communication mode, creating a file of a monochrome format on the basis of the input image; and
transmission means for transmitting the file of the monochrome format.

2. The apparatus according to claim 1, further comprising color scanning means for, when the scanning mode is the color mode, scanning the input image in the color mode and generating color scanned data,
wherein said communication mode determination means determines the communication mode used to transmit the color scanned data, and
said file creation means creates a file of the monochrome format on the basis of the color scanned data.

3. The apparatus according to claim 1, wherein when the communication mode is the monochrome mode, said file creation means scans the input image in the monochrome mode, and creates a file of the monochrome format.

4. The apparatus according to claim 1, wherein
when the scanning mode is the monochrome mode, said file creation means scans the input image in the monochrome mode, and creates a file of the monochrome format, and
said transmission means transmits the monochrome data file.

5. The apparatus according to claim 1, wherein said scanning mode determination means determines the scanning mode of the input image on the basis of a mode input by mode input means.

6. The apparatus according to claim 5, wherein the mode input means includes a color start key and a monochrome start key.

7. The apparatus according to claim 1, wherein said communication mode determination means determines the communication mode on the basis of the communication mode of abbreviated dialing.

8. An image processing method of generating image data to be transmitted to a predetermined network, comprising:
a scanning mode determination step of determining whether a scanning mode of an input image is a monochrome mode or a color mode;
a communication mode determination step of, when the scanning mode is the color mode, determining a communication mode representing a mode used to transmit the input image;
a file creation step of, when a determination result in the communication mode determination step represents a monochrome communication mode, creating a file of a monochrome format on the basis of the input image; and
a transmission step of transmitting the file of the monochrome format.

9. The method according to claim 8, further comprising a color scanning step of, when the scanning mode is the color mode, scanning the input image in the color mode and generating color scanned data,
wherein in the communication mode determination step, the communication mode used to transmit the color scanned data is determined, and
in the file creation step, a file of the monochrome format is created on the basis of the color scanned data.

10. The method according to claim 8, wherein in the file creation step, when the communication mode is the monochrome mode, the input image is scanned in the monochrome mode to create a file of the monochrome format.

11. The method according to claim 8, wherein
in the file creation step, when the scanning mode is the monochrome mode, the input image is scanned in the monochrome mode to create a file of the monochrome format, and
in the transmission step, the monochrome data file is transmitted.

12. The method according to claim 8, wherein in the scanning mode determination step, the scanning mode of the input image is determined on the basis of a mode input in a mode input step.

13. The method according to claim 12, wherein in the mode input step, press of a color start key and a monochrome start key is detected.

14. The method according to claim 8, wherein in the communication mode determination step, the communication mode is determined on the basis of the communication mode of abbreviated dialing.
